(19) United States
(12) Patent Application Publication
(10) Pub. No.: US 2020/0253419 A1
(43) Pub. Date: Aug. 13, 2020

(54) A PORTABLE ELECTRIC GRILL

(71) Applicant: ARCELIK ANONIM SIRKETI, Istanbul (TR)

(72) Inventors: Samet AKAN, Istanbul (TR); Ali Levent HASANREISOGLU, Istanbul (TR); Omer Burak COBAN, Istanbul (TR)

(21) Appl. No.: 15/781,457

(22) PCT Filed: Nov. 30, 2016
(86) PCT No.: PCT/EP2016/079210

§ 371 Date: Jun. 4, 2018

(30) Foreign Application Priority Data
Dec. 8, 2015 (TR) 2015/15605

(51) Int. Cl. A47J 37/07; A47J 37/04

(52) U.S. Cl. CPC A47J 37/0709; A47J 37/0745; A47J 37/041

(57) ABSTRACT

The present invention relates to an electric grill comprising a body, a rod whereon the foodstuffs to be roasted are spitted, and at least one skewer having a handle connected to one end of the rod.

The present invention relates to a portable electric grill with increased roasting efficiency.

In portable electric grills, foodstuffs can be roasted on a grill grate or by being spitted on skewers. In some portable grills, the skewers can be rotated by means of motors each of which rotates a single skewer or by means of rotating mechanisms such as pulleys, gears, etc. which are connected to a single motor so as to both provide ease of use to the users and allow the foodstuff to be roasted homogenously. However, distance of the skewers to the heaters is critically important in terms of roasting of the foodstuff in an ideal way. If the skewers are positioned far from the heaters, both the roasting performance decreases and the roasting time prolongs due to the loss of energy. When the skewers are positioned close to the heaters, on the other hand, large size foodstuff cannot be placed on the electric grill due to the limited distance between the skewer and the heater. In this case, since any large size foodstuff is required to be cut into smaller parts, it creates difficulty of use for the users. In the state of the art, there are apparatuses of various forms disposed on the skewers, the height of which can be adjusted. However, since the skewers are connected to the body or the apparatus by means of complicated mechanical mechanisms which rotate the skewers, height adjustment cannot be easily performed. Moreover, excess number of moving parts may also cause safety vulnerabilities. Therefore, there is a need for a portable electric grill suitable for roasting on a skewer, wherein both small and large size foodstuffs can be roasted homogenously, providing improved safety.

In the state of the art United States Patent Document No. US20120285338, a grill apparatus which has gears rotated by a motor and chains attached to the gears that provide the rotating of the skewers is disclosed. The grill apparatus is suitable for use on various types of grills, and height of the skewers can be changed by adjusting the length of the feet of the grill apparatus by means of a clamp screw.

The aim of the present invention is the realization of a portable electric grill with improved roasting efficiency.

The portable electric grill realized in order to attain the aim of the present invention, explicated in the claims, comprises a body and at least one skewer that has a rod whereon the foodstuffs to be roasted are spitted and a handle attached to one end of the rod.

In the electric grill of the present invention, the distance of the skewer to the heater can be increased by means of a platform that is seated on the body, whereon the skewer is placed. The platform provides the transmission of the electrical current supplied from the body to the handle and thereby a motor disposed inside the handle is energized and the rod can be rotated automatically. Thus, a portable electric grill with simplified structure and improved safety is obtained wherein large size foodstuffs placed on the platform are rotated automatically.

In an embodiment of the present invention, the skewer is placed on the body and the platform by seating the handle into the recess-shaped housings arranged on the body and the platform. Thus, the position of the skewer on the electric grill is determined and any roasting defect which may be caused by the wrong positioning of the skewer is prevented.

In another embodiment of the present invention, at least two first connectors with an electrical potential difference therebetween are provided on the housing. On the handle, there are at least two second connectors that enable the electrical terminals of the motor to be supplied with the potential difference between the first connectors when the handle is placed into the housing so that two of them each come into contact with a first connector. Thereby when the handle is placed into the housing, the rod is rotated automatically. Thus, use of the skewer is simplified.

In another embodiment of the present invention, there are at least two pairs of first connectors on the housing that are supplied with different voltages provided from the body and the motor is supplied with different voltages in each position at which the handle is seated into the housing so that the second connectors come into contact with a different pair of first connectors. Thus, when the position of the handle inside the housing is changed, the voltage supplied to the motor changes as well and the rod is rotated at varying revolutions. Thereby the rotational speed of the rod can be easily adjusted according to different sorts of foodstuff such as meat, vegetable, etc.

In another embodiment of the present invention, the platform is connected to the body by means of at least one foot seated into the housing and the second connectors disposed on the foot come into contact with the first connectors on the body, providing the transmission of the electrical current from the body to the platform. Thus, the electrical connection between the platform and the body can be made easily and safely.

In another embodiment of the present invention, a wire in the form of an U is disposed on the platform so that the ends thereof are connected to the platform. One end of the wire is bent toward the body so as to bear against the wall of the body. Thus, the weight of the platform and the skewer that bears the foodstuff is evenly distributed across the body and the platform is enabled to stand on the body in a stable manner.

In another embodiment of the present invention, a support extends between the arms of the wire that are connected to the platform. When the handle is placed into the housing, the tip of the wire touches the support. Thereby the rod is supported from both ends and the skewer is prevented from dislodging from the housing in the cases the skewer is heavily loaded.

In another embodiment of the present invention, a bend in the form of a recess is provided on the support, wherein the tip of the rod is seated when the handle is placed into the housing. The bend enables the tip of the rod to be held in the correct position on the support. Thus, the rod is enabled to extend in parallel with the heaters at all times.

In another embodiment of the present invention, at least one pair of first connectors is positioned on the opposite walls of the housing so as to face each other. Since the first connector is not disposed at the base of the housing, when the handle is seated into the housing so that one of the second connectors faces the base of the housing, no energy is transmitted to the handle and the rod remains immobile. Thus, the skewers can be manually used.

By means of the present invention, a platform with a compact and simple structure that allows the efficient roasting of large size foodstuffs by rotating is obtained. Thus, the use of the portable electric grill is facilitated.

The portable electric grill realized in order to attain the aim of the present invention is illustrated in the attached figures where

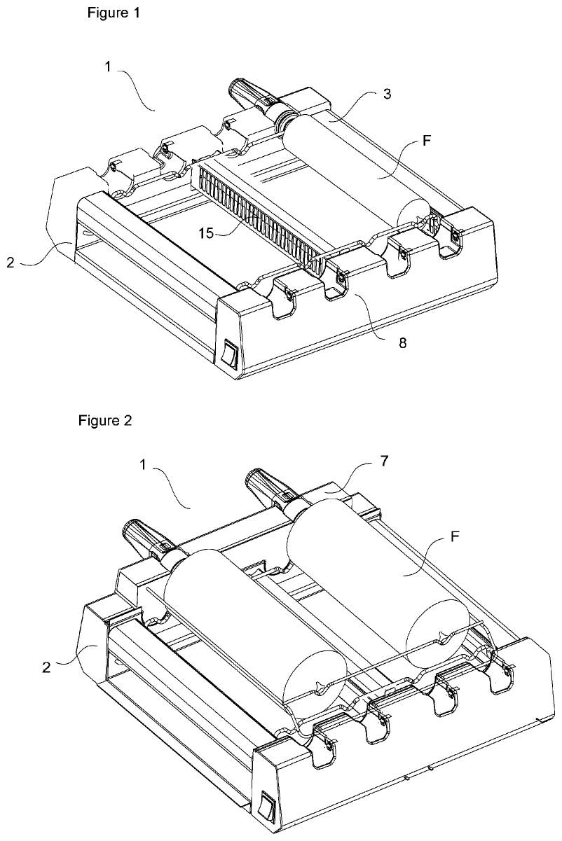

FIG. 1—is the view of the portable electric grill related to an embodiment of the present invention.

FIG. 2—is the view of the portable electric grill related to another embodiment of the present invention.

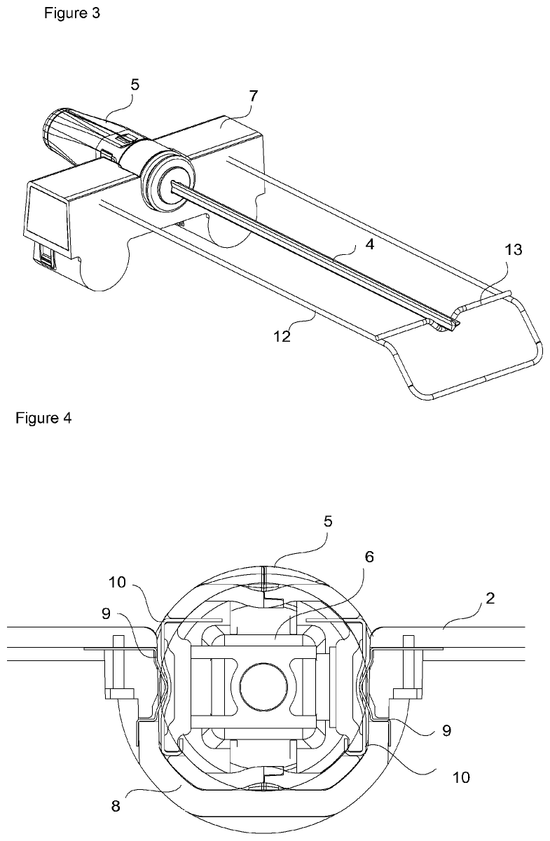

FIG. 3—is the view of the platform and the skewer related to another embodiment of the present invention.

FIG. 4—is the partial schematic cross-sectional view of the portable electric grill related to another embodiment of the present invention.

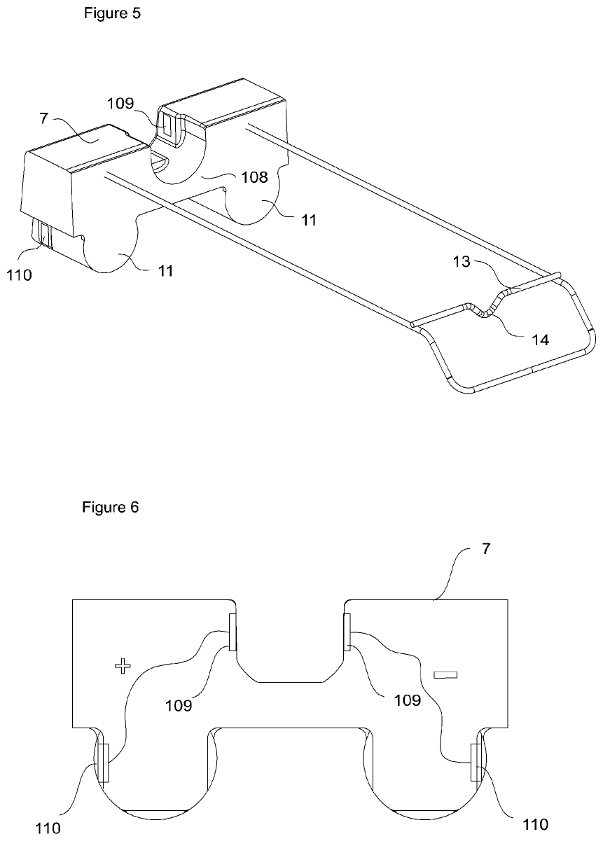

FIG. 5—is the perspective view of the platform related to another embodiment of the present invention.

FIG. 6—is the schematic cross-sectional view of the platform related to another embodiment of the present invention.

The elements in the figures are numbered as follows:
1. Electric grill
2. Body
3. Skewer
4. Rod
5. Handle
6. Motor
7. Platform
8, 108. Housing
9, 109. First connector
10, 110 Second connector
11. Foot
12. Wire
13. Support
14. Bend
15. Heater
F: Foodstuff

The electric grill (1) comprises a body (2), a rod (4) on which the foodstuffs (F) to be roasted are spitted, and at least one skewer (3) having a handle (5) that is connected to one end of the rod (4). The electric grill (1) has also heaters (15). The foodstuffs (F) on the skewer (3) are roasted by means of the electric heaters (15) disposed in the body (2).

The electric grill (1) of the present invention comprises a motor (6) that is disposed in the handle (5) and that, when energized by the electrical current supplied from the body (2), rotates the rod (4), and a platform (7) that is detachably positioned on the body (2) and that, when the skewer (3) is placed thereon, provides the transmission of the electrical current from the body (2) to the motor (6). Where the platform (7) is not disposed on the body (2), the skewers (3) are directly placed on the body (2) and the electrical current is transmitted from the body (2) to the handle (5), thus supplying the motor (6) (FIG. 1). The motor (6) is connected to the rod (6) by means of a shaft. Thus, when the handle (5) is placed on the body (2), small size foodstuffs spitted on the skewer (3) are rotated automatically and can be roasted homogenously. When any skewer apparatuses in the form of a drum that enable roasting of large size foodstuffs (F) or different kinds of foodstuffs (F) such as corn, potato, etc., which is connected on the rod (4), are wanted to be placed on the body (2), the platform (7) is placed on the body (2) and the skewers (3) are arranged on the platform (7) (FIG. 2). Thereby the distance of the skewers (3) to the heaters (15) and the base of the body (2) is increased and large size foodstuffs (F) or skewer apparatuses can be placed on the body (2). The platform (7) also provides the transmission of the electrical current between the body (2) and the motor (6). Thus, when the skewer (2) is placed on the platform (7), the rod (4) can be rotated automatically. Thus, large size foodstuffs (F) can be easily placed on the electric grill (1) and roasted homogenously.

In another embodiment of the present invention, on the body (2) and the platform (7) each, at least one housing (8, 108) into which the handle (5) is placed is arranged. The skewer (3) is placed on the body (2) and the platform (7) by seating the handle (5) into the groove-shaped housing (8, 108). Thus, the skewer (3) can always be placed in a correct position and immobile manner on the body (2).

In another embodiment of the present invention, there are at least two first connectors (9, 109) on the housing (8, 108), which are supplied with different electrical voltages provided from the body (2), and more than one second connector (10) on the handle (5), which, when the handle (5) is placed into the housing (8, 108) such that at least two thereof come into contact with one of the first connectors (9, 109), provides the transmission of the electrical current supplied from the body (2) to the motor (6) (FIG. 4). The second connectors (10) which are connected to the electrical inlets and outlets of the motor (9) are in contact with the first connectors (9, 109) when the handle (5) is in the housing (8, 108). The second connector (10) coming into contact with a first connector (9, 109) which has high voltage provides the transmission of the electrical current supplied from the body (2) to the motor (6). The current circulated through the motor (6) reaches the second connector (10) which is in contact with another first connector (9, 109) which has low voltage, and transmitted back to the body (2). Thus, when the handle (5) is seated into the housing (8, 108), the circuit is completed and the rod (4) is rotated automatically. Thus, the use of the portable electric grill (1) is facilitated.

In another embodiment of the present invention, the handle (5) can be placed into the housing (8, 108) in more than one different position and the motor (6), by being supplied with voltage from a different pair of first connectors (9, 109) in at least two different positions of the handle (5) within the housing (8, 108), provides the rotation of the rod (4) at different speeds. When the handle (5) is placed into the housing (8, 108) so that the second connectors (10) come into contact with a pair of first connectors (9, 109) between which there is relatively low voltage, the motor (6) is supplied with low voltage and the rod (4) is rotated at a slower speed. When the foodstuffs (F) are wanted to be rotated at a higher speed, the handle (5) is placed into the housing (8, 108) so that the second connectors (10) come into contact with a pair of first connectors (9, 109) between which there is relatively a higher potential difference. Thereby, the rotational speed of the rod (4) can be easily adjusted by changing the position of the handle (5) within the housing (8, 108).

In another embodiment of the present invention, the platform (7) has at least one foot (11) that is seated into the housing (8) when the platform (7) is placed on the body (2) and there are more than one second connector (110) on the foot (11), at least two of which come into contact with one first connector (9) each when the platform (7) is placed on the body (2), providing the transmission of the electrical current from the body (2) to the platform (7). The foot (11) can be easily seated into the housing (8) and enables the platform (7) to be placed on the body (2) in an immobile manner. When the foot (11) is inside the housing (8), the second connectors (110) on the foot (11) come into contact with the first connectors (9) on the body (2) and provide the transmission of the voltage carried by the first connectors (9) to the first connectors (109) on the platform (7) (FIG. 6). Thus, when the skewer (3) is placed on the platform (7), the motor (6) is supplied with the electrical current provided from the body (2) and the foodstuffs (F) are rotated automatically.

In another embodiment of the present invention, there is a wire (12) on the platform (7), which extends over the body (2) so as to be connected from the ends thereof to the platform (7), at least a section of the wire (12) bearing against the wall of the body (2), thus enabling the platform (7) to be supported. When the platform (7) is on the body (2), the side of the platform (7) that extends parallel to the platform (7) is bent toward the wall of the body (2) so as to come into contact with the wall of the body (2). Thus, the platform (7) can be placed in a balanced manner on the body (2) and the platform (7) is prevented from overturning in such cases as the users inadvertently bumping on the platform (7), etc.

In another embodiment of the present invention, the wire (12) has a support (13) that extends between the parallel edges thereof and against which the tip of the rod (4) bears when the skewer (3) is placed on the platform (7). Thus, by enabling the rod (4) to be supported from both ends thereof, the skewer (3) is prevented from bending toward the base of the body (2) when excessively loaded. Consequently, any operational fault resulting from the failure of the handle (5) to be seated into the housing (108) is prevented.

In another embodiment of the present invention, the support (13) has a bend (14) wherein the tip of the rod (4) is seated when the skewer (3) is placed on the platform (7). Thus, the skewer (3) is enabled to be placed on the platform (7) so that the rod (4) is always parallel with the heaters (15). Thereby all surfaces of the foodstuffs (F) are uniformly roasted.

In another embodiment of the present invention, the cross-section of the housing (8, 108) in the vertical plane is in the form of a U and there is at least one first connector (9, 109) on each of the opposite surfaces of the housing (8, 108). Since the first connector (9, 109) is not provided at the base of the housing (8, 108), when the handle (5) is placed into the housing (8, 108) so that one of the second connectors (10) faces the base of the housing (8, 108), energy is transmitted to the motor (6). Thus, when the handle (5) is rotated 90 degrees around its own axis and replaced into the housing (8, 108) while the rod (4) is in a position wherein the same is rotated automatically, the rod (4) stays immobile. Thus, the skewers (3) can be used manually as well.

In the electric grill (1) of the present invention, the platform (7) enables large size foodstuffs (F) placed thereon to be roasted by being rotated at an adequate distance to the heaters (15) and at an appropriate speed. The platform (7) also allows any apparatuses in cage form used for popping corn or roasting potato and suitable to be fitted over the skewers (3) to be placed on the body (2). Thus, a portable electric grill (1) wherein different types and sizes of foodstuffs (F) can be roasted without making any structural change on the body (2) or without need for different sizes of skewers (3) is obtained.

1. An electric grill comprising a body, a rod whereon the foodstuffs to be roasted are spitted, and at least one skewer having a handle that is connected to one end of the rod, characterized by a motor that is disposed in the handle and that, when energized by the electrical current supplied from the body, rotates the rod, and a platform that is detachably positioned on the body and that, when the skewer is placed thereon, provides the transmission of the electrical current from the body to the motor.

2. The electric grill as in claim 1, characterized by at least one housing disposed on each of the body and the platform, wherein the handle is placed.

3. The electric grill as in claim 2, characterized by at least two first connectors disposed on the housing, which are supplied with different electrical voltages provided from the body, and more than one second connector disposed on the handle, which, when the handle is placed into the housing such that at least two thereof come into contact with one of the first connectors, provides the transmission of the electrical current supplied from the body to the motor.

4. The electric grill as in claim 3, characterized by a handle that can be placed into the housing in more than one different position and the motor that, by being supplied with voltage from a different pair of first connectors in at least two different positions of the handle within the housing, provides the rotation of the rod at different speeds.

5. The electric grill as in claim 3, characterized by at least one foot that is disposed on the platform and that is seated into the housing when the platform is placed on the body and more than one second connector disposed on the foot, at least two of which come into contact with one first connector each when the platform is placed on the body, providing the transmission of the electrical current from the body to the platform.

6. The electric grill as in claim 1, characterized by a wire that is connected to the platform from the ends thereof, at least a section of the wire bearing against the wall of the body, thus enabling the platform to be supported when the platform is on the body.

7. The electric grill as in claim 6, characterized by a support that extends between the parallel sides of the wire and against which the tip of the rod bears when the skewer is placed on the platform.

8. The electric grill as in claim 7, characterized by a bend that is disposed on the support and wherein the tip of the rod is seated when the skewer is placed on the platform.

9. The electric grill as in claim 3, characterized by the housing of which the cross-section in the vertical plane is in the form of a U, having at least one first connector disposed on each of the opposite surfaces thereof so as to face each other.

10. The electric grill as in claim 4, characterized by at least one foot that is disposed on the platform and that is seated into the housing when the platform is placed on the body and more than one second connector disposed on the foot, at least two of which come into contact with one first connector each when the platform is placed on the body, providing the transmission of the electrical current from the body to the platform.

11. The electric grill as in claim 4, characterized by the housing of which the cross-section in the vertical plane is in the form of a U, having at least one first connector disposed on each of the opposite surfaces thereof so as to face each other.
